(19) United States
(12) Patent Application Publication
(10) Pub. No.: US 2009/0138159 A1
(43) Pub. Date: May 28, 2009

(54) Safety System for a Vehicle

(75) Inventors: Frank Ewerhart, Weinsberg (DE); Reiner Marchthaler, Gingen (DE); Thomas Lich, Schwaikheim (DE); Stephan Stabrey, Stuttgart (DE); Georg Mayer, Ditzingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/919,298

(22) PCT Filed: Apr. 10, 2006
(86) PCT No.: PCT/EP2006/061494

§ 371 Date: Jan. 16, 2009

(30) Foreign Application Priority Data
May 17, 2005 (DE) 10 2005 022 678.7

(51) Int. Cl. B60R 21/0132

(52) U.S. Cl. 701/45

(57) ABSTRACT

A safety system for a vehicle having at least one safety device, which records and/or ascertains and evaluates one or a plurality of variable(s) regarding driving dynamics to activate at least one protection device. In response to user-dependent inputs, a parameterization device specifies settings and/or applications and/or parameters for the safety device in order to influence the trigger behavior of the at least one protection device.

### FIELD OF THE INVENTION

The present invention relates to a safety system for a vehicle.

### BACKGROUND INFORMATION

German Patent Application No. DE 102 50 732 B3 describes a control device for the preventive triggering of reversible and irreversible passenger and/or partner protection devices in a motor vehicle. The described control device includes a decision stage, which outputs a trigger decision for the passenger protection means if, utilizing variables relating to driving dynamics, a safety-critical driving behavior of the vehicle is ascertained. Furthermore, the described control device includes a plausibilization stage to subject the trigger decision to a plausibility check. The plausibilization stage evaluates the trigger decision as implausible and prevents the triggering of the passenger and/or partner protection means if an evaluation of the time characteristic of variables determined inside the vehicle, such as steering angle, pedal actuation, yaw rate or transversal acceleration, comes to the result that, within specifiable limits, the safety-critical driving behavior corresponds to a desired driving behavior.

The problem in the triggering of reversible protection devices for safety, e.g., a reversible belt tightener, is finding an optimal setting for these protection devices for the user from a multitude of degrees of freedom. For instance, safety systems in which only the reversible passenger protection devices on the passenger side are triggered are used in vehicles in order not to startle the driver by the tightening operation.

### SUMMARY

An example safety system of the present invention for a vehicle may have the advantage that, due to a parameterization device, the trigger behavior of at least one protection device is able to be individually adjusted to a user, i.e., a driver and/or passenger, while taking the safety aspect into account. As a result, the parameterization device is advantageously able to adapt the trigger behavior of at least one protection device to different types of users by an input of settings and/or applications and/or parameters, thereby increasing customer satisfaction and the acceptance of such systems.

It is especially advantageous if data regarding driving dynamics are recorded and/or ascertained by at least one sensor unit and/or an electronic stability program to activate at least one protection device. This makes it possible to combine sensor data from active safety systems such as an electronic stability system, with sensor data from a passive safety system.

The parameterization device has an input unit and/or an identification unit for the user-dependent specifications, via which individual parameters of a user with respect to height and/or age and/or weight and/or gender and/or health status such as pregnancy, handicap etc., and/or driving style are able to be input and/or automatically ascertained. Following the input or following the automatic determination, the individual parameters of the user may advantageously be stored in the parameterization device in a manner that allows them to be called up. However, the stored parameters may also be overwritten, if necessary.

The input unit, which encompasses a manual input device and/or an electronic input device and/or a voice input device, for instance, advantageously allows the user to set freely selectable and/or fixedly preset applications having different parameters for the driver and/or the passenger. That means that, for instance, a dynamic driver is able to select a trigger behavior for the at least one protection means that is suitable for him or her, in a menu-driven manner via the input unit, such as a belt tightener, an active vehicle seat, etc., so that the safety system ensures the safety function but has a pleasant effect on the driver. A different type of driver is able to select a different setting having other parameters, which activate the belt tightener and/or the active vehicle seat earlier, for example.

The identification unit advantageously allows an automatic acquisition of the individual parameters of the user. The identification unit includes, for instance, an arrangement for driver identification, which record the user-dependent specifications during the ride by analyzing the driving style of the user, and/or an arrangement for passenger identification, which detect a passenger seat occupancy and/or identify the passengers in order to call up the associated stored individual parameters. In this manner the settings and/or the applications and/or the parameters for the trigger behavior of the at least one safety device may advantageously be implemented following a one-time inputting of the parameters.

The settings and/or applications and/or parameters for the safety device specify, for example, activation information and/or deactivation information and/or a trigger duration and/or trigger threshold values and/or a triggering intensity for the protection devices. The protection device includes, for example, reversible passenger protection devices, such as belt tighteners, active vehicle seats, and/or reversible pedestrian protection devices, such as a raisable engine hood.

In an advantageous manner, in response to user-dependent inputs, the parameterization device is able to specify settings and/or applications and/or parameters for communication systems such as a telephone, emergency call, hazard-warning and turn-signal system etc., and/or for comfort systems such as a sliding sunroof, seat adjustment system, tank and door control system etc.

### BRIEF DESCRIPTION OF THE DRAWINGS

Exemplary embodiments of the present invention are illustrated in the figures and explained in greater detail below:

FIG. 1 shows a schematic block diagram of a safety device for a vehicle.

FIG. 2 shows a schematic block diagram of a parameterization device for the safety device from FIG. 1.

### DETAILED DESCRIPTION OF EXAMPLE EMBODIMENTS

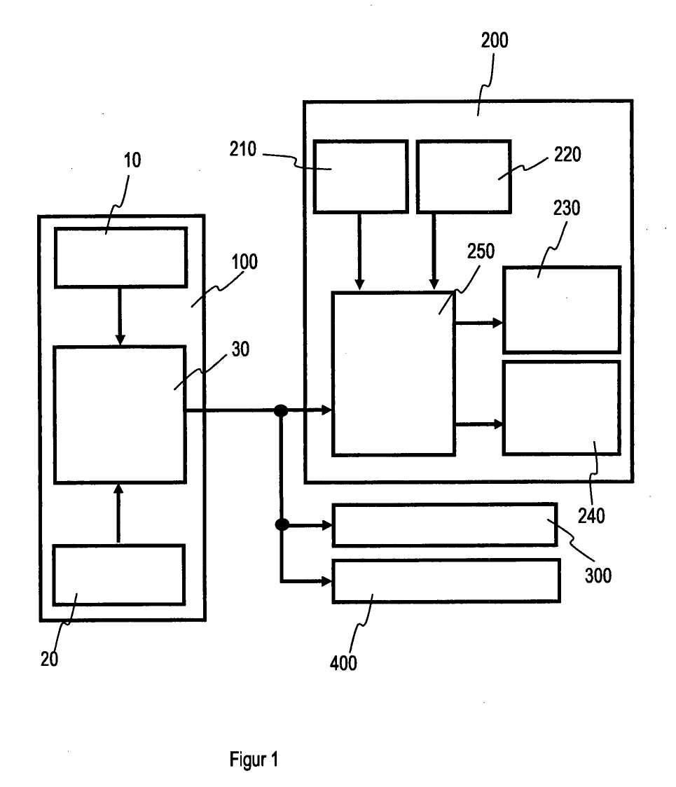

As shown in FIG. 1, a safety system for a vehicle includes a parameterization device 100 and a safety device 200. Safety device 200 includes a sensor unit 210 and a vehicle dynamics system 220, such as an electronic stability system, which records and/or determines variables relating to driving dynamics, for instance the vehicle velocity, roll rate, yaw rate, vehicle acceleration, etc., and it includes a reversible passenger protection device 230 such as a belt tightener, an active vehicle seat etc., and/or reversible pedestrian protection device 240, for instance an engine hood raising mechanism, and a trigger unit 250. The active vehicle seat includes a plurality of air cushions, for example, which are able to be inflated very rapidly as a function of the particular driving situation so as to provide improved side support of the passenger. Parameterization device 100 includes an input unit 10, an identification unit 20, and an evaluation and control unit 30.

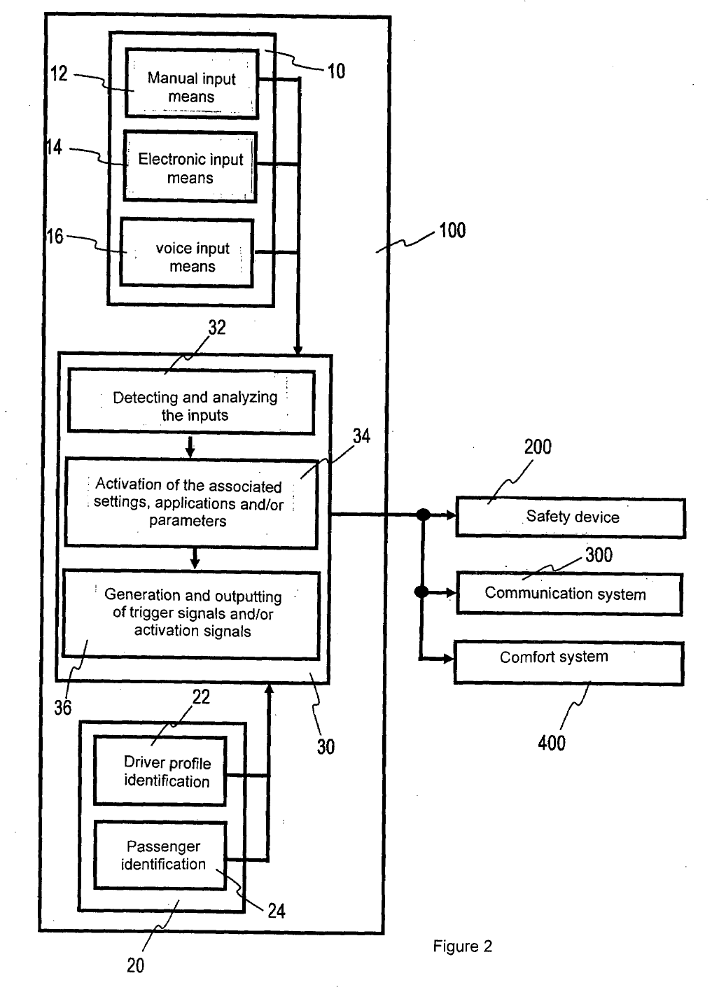

As shown in FIG. 2, input unit 10 includes manual input devices 12, such as switches, non-locking switches, joystick etc., and/or an electronic input device 14, such as a touch screen, portable memory elements, memory sticks, chip cards etc., and/or a voice input device 16 for inputting the user-dependent specifications, for example individual parameters of a user with regard to height and/or age and/or weight and/or gender and/or health status such as pregnancy, handicap etc., and/or driving style. Identification unit 20 includes a driver identification device 22, which records the user-dependent inputs during the ride by analyzing the driving style of the user, and/or a passenger identification device 24, which detects a passenger seat occupancy and/or identifies the passengers so that stored individual parameters may be called up. In a block 32, evaluation and control unit 30 records the inputs, i.e., the individual characteristic data, of input unit 10 and/or identification unit 20, and evaluates the data. In block 34, evaluation and control unit 30 activates the associated settings and/or applications and/or parameters, which, for example, include activation information and/or deactivation information and/or a trigger duration and/or trigger threshold values and/or a triggering intensity for the protection devices, and generates trigger signals and/or activation signals in block 36, which are output to safety device 200, a communication system 300, and a comfort system 400.

To activate at least one of the protection devices 230, 240, trigger unit 250 of safety device 200 evaluates one or a plurality of the acquired and/or ascertained variables relating to driving dynamics, and generates trigger signals for protection devices 230, 240 as a function of the trigger signals and/or activation signals, which are transmitted by evaluation and control unit 30 and which represent settings and/or applications and/or parameters for influencing the trigger behavior of protection devices 230, 240.

The safety system of the present invention for a vehicle advantageously provides the option of selecting, via input unit 10, by manual and/or electronic and/or haptic and/or voice input, a freely selectable and/or fixedly preset application having different parameters and/or settings for driver and/or passenger. In this way a dynamic driver may select an application of reversible protection devices 230, 240 that is suitable for him or her, so that the safety system has a pleasant effect on the driver yet still ensures the safety function. Another type of driver may select a different setting, which, for instance, activates protection devices 230, 240 earlier and on the basis of different parameters. In the case of a reversible belt tightener 230, for instance, different time spans may be selected for the triggering, and a different intensity of the triggering or a different level of force and different activation onsets and/or end points at which the system becomes active or inactive, may be selected.

Via parameterization device 100, at least one activated state and one deactivated state may be set for the protection devices. In one possible specific embodiment, parameterization device 100 deactivates and/or activates the at least one protection device 230, 240 as a function of the user input, two additional inputs being possible for the activated state. For instance, for an average driver, the settings and/or applications and/or parameters may be specified for a sensitive triggering of protection devices 230, 240, and for a dynamic driver a less sensitive triggering of protection devices 230, 240 may be input. Parameterization device 100 provides the trigger signals and/or activation signals preferably to safety devices 200 having reversible protection devices, such as a belt tightener 230, an active vehicle seat, or an engine hood raising mechanism 240. However, other systems such as comfort systems, for instance a sunroof, seat adjustment system, tank and door control system etc., and/or communication systems such as telephone, emergency call, hazard-warning system etc., may be triggered in addition. If a plurality of safety devices 200 is disposed in the vehicle, then a parameterization device 100 may be provided for each of the safety devices 200. As an alternative, one parameterization unit may trigger all provided safety devices 200 via corresponding interfaces.

1-10. (canceled)

11. A safety system for a vehicle, comprising:
at least one safety device adapted to at least one of record, ascertain and evaluate, at least one variable relating to driving dynamics, for activating at least one protection device; and
a parameterization device, which, in response to user-dependent specifications, specifies at least one of settings, applications, and parameters for the safety device in order to influence a trigger behavior of the at least one protection device.

12. The safety system as recited in claim 11, wherein data regarding driving dynamics are at least one of recorded and ascertained, by at least one of: i) at least one sensor unit, and ii) a driving-dynamics system.

13. The safety system as recited in claim 11, wherein the parameterization device includes at least one of an input unit and an identification unit, for the user-dependent inputs, via which individual parameters of a user with regard to at least one of height, age, weight, gender, health status, and driving style are able to be at least one of input and automatically determined.

14. The safety system as recited in claim 13, wherein the individual parameters of the user are stored in the parameterization device so as to be able to be called up.

15. The safety system as recited in claim 13, wherein the input unit includes at least one of manual input device, an electronic input device, and a voice input device.

16. The safety system as recited in claim 13, wherein the identification device includes at least one of: i) a device adapted for driver identification, which detects at least one of the user-dependent specifications during a ride by analyzing a driving style of the user, and ii) a device adapted for passenger identification, which at least one of detects a passenger-seat occupancy, and identifies at least one of the passenger for calling up the individual parameters.

17. The safety system as recited in claim 11, wherein at least one of the settings, applications, and parameters for the safety device specify at least one of activation information, deactivation information, a trigger duration, trigger threshold values, and a triggering intensity for the protection device.

18. The safety system as recited in claim 11, wherein the parameterization device is adapted to at least one of deactivate and activate the at least one safety device as a function of the user input, it being possible in the activated state to specify the at least one of the settings, applications, and parameter, for an average driver for a sensitive setting of the protection device, and for a less sensitive setting of the protection device for a dynamic driver.

19. The safety system as recited in claim 18, wherein the protection device includes at least one of a reversible passenger protection device and a reversible pedestrian protection device.

20. The safety system as recited in claim 11, wherein, in response to user-dependent inputs, the parameterization device specifies at least one of settings, applications, and parameters for at least one of a communication system, and a comfort system.
